(19) United States
(12) Patent Application Publication
(10) Pub. No.: US 2020/0188066 A1
(43) Pub. Date: Jun. 18, 2020

(54) BIOINERT BODY

(71) Applicants: Dr. Christian Kasperk, Heidelberg (DE); Dr. Andreas Haas, Sandhausen (DE)

(72) Inventor: Andreas Haas, Sandhausen (DE)

(73) Assignees: Dr. Christian Kasperk, Heidelberg (DE); Dr. Andreas Haas, Sandhausen (DE)

(21) Appl. No.: 16/690,571

(22) Filed: Nov. 21, 2019

(30) Foreign Application Priority Data
Nov. 28, 2018 (DE) 102018130153.7

(51) Int. Cl. A61C 8/00

(52) U.S. Cl. CPC A61C 8/0012; A61C 2008/0046; A61C 8/0018; A61C 8/0087

(57) ABSTRACT

The invention relates to a bioinert body having a base body, which grows to a multiple of its volume when hydrated. The base body substantially consists of dried laminaria parts, which also develop a local antibacterial effect due to the iodine content. The bioinert body is suitable for application in a method of tissue augmentation.

The invention relates to a bioinert body having a base body, the volume of which is variable.

To prepare for the provision of a dental implant or for a better fit of a full prosthesis, it is often necessary to insert an implant material subperiosteally, where osseous healing can then take place. Often, however, the bone availability, i.e. the vertical and horizontal dimensions of the jawbone, is inadequate for the insertion of an implant into the bone. In this case, measures are needed to build up the bone, so-called bone augmentations or sinus floor elevations where this occurs in the paranasal sinus region.

The oral mucosa is directly and firmly attached to the bone. In the case of extensive bone augmentations, therefore, there can be insufficient mucosa, i.e. soft tissue, so that it is no longer possible to achieve an adequate, tension-free closure of the mucosa, which has necessarily been cut for the operation, over the space-occupying and sensitive bone graft that has been inserted.

While it is true that the mucosa itself can be stretched, however, it is anatomically in direct contact with the non-stretchable periosteum and is fused therewith. Ideally therefore, the mucosa adjacent to the alveolar ridge and the periosteum directly adjacent to the bone first have to be mobilized and stretched together so that sufficient space can be created under the oral mucoperiosteal layer, into which the bone graft can be inserted.

In some cases, a stretching of the mucosa and thus a wound closure can be achieved by so-called periosteal slitting. However, this procedure involves several problems.

It is necessary for wound closure that the mucosa, together with the periosteum, is detached from the bone further than was previously necessary without a graft. However, this involves the risk that this part of the detached mucosa will not be attached to the bone again in the same way and the mucosa which was previously firmly attached to the bone will thus remain mobile. This can be unfavorable for the planned implantation and can require further operations in the further course of treatment, such as vestibuloplasty or lowering of the floor of the mouth. The reason for this lies in the decrease in the so-called “attached” gingiva that this causes.

For good integration of the bone graft under the sutured mucosa, the entire graft should ideally be completely covered by periosteum. This is necessary because ossification only originates from the periosteum. However, where the periosteum is slit, the mucosa is in direct contact with the graft over a large area in the region of the slit. An osseous integration and healing of the graft is problematic at these points.

In addition, when the periosteum is slit, it is extremely easy for not only the periosteum to be severed but also the adjacent mucosa together with the supplying blood vessels and capillaries, such that in this very unfavorable case the survival of the mucosa is at risk. As a result of this, the healing of the entire graft is often no longer possible, since a saliva-proof wound closure by the cut mucosa becomes impossible.

Furthermore, by stretching the mucosa over the bone graft when suturing, it is also possible for undersupply of the stretched mucosa to occur as a result of impaired circulation (reduced perfusion). This ultimately leads to necrosis of the oral mucosa, so-called pressure necrosis, which in turn leads to the perforation of the oral mucosa and exposure of the bone graft in the oral cavity. As a result, it is highly likely that the graft will become infected and will be lost.

The possible complications are therefore infections, insufficient alveolar ridge augmentations, wound and healing impairments of the oral mucoperiosteal layer and similar.

It is already known to insert plastic, liquid-fillable expansion bodies under the oral mucoperiosteal layer and to fill them. When filled with liquid, these can increase their volume by no more than double. Liquid-filled expansion bodies also exist, which become enlarged as a result of water absorption, following an osmotic gradient, such that no filling has to take place in this case. Here too, only a doubling of the volume is described. Although some of the problems presented above can be remedied by these means, however, insufficient tissue is generally obtained to allow the method outlined above to be completely omitted.

The present invention is therefore based on the object of providing a body that can contribute to tissue augmentation and causes as few complications as possible when applied in the human body.

This object is achieved according to the invention by a bioinert body having the features of claim 1.

Advantageous embodiments of the invention are given in the sub claims and the description.

According to the invention, the bioinert body has a base body. This swells or grows to at least four times its volume when hydrated and consists substantially of dried and processed laminaria limb or branch parts. It is for use in a method of tissue augmentation.

Hydration within the meaning of the invention can be understood in particular as bringing into contact with water, tissue fluid or blood/serum.

Laminaria are brown algae with circumpolar distribution, which grow in the eulittoral zone of oceanic coasts in the northern hemisphere. With the aid of anchoring organs, the rhizomes, these marine algae that grow up to 5 m tall are firmly attached to rocky substrates, holding the up to 4 cm thick stipe which supports the several metre long blade of the seaweed.

The attaching stipe or branch of the laminaria seaweed consists of polysaccharides and polygalactosides as well as other polymerised sugar molecules, such as e.g. phycocolloids, alginic acid, polyguluronic acid and polymannuronic acid, which cannot be broken down by enzymes in the mammalian organism.

The material of the stipes or branches of these laminaria seaweeds is extremely well adapted to wave exposure in the shore areas where the seaweed grows, combining very high strength and flexibility. This is achieved by the fact that the polymer chains of the plant stipes are very rich in water, up to 80%, and yet highly resistant to tearing.

If these laminaria stipes are dried, the diameters of the stipes shrink to about a fifth of their initial diameter. If these dried stipes are put back in water, the stipes swell back to their initial diameter.

The invention is based on the finding that the application of a base body composed of dried laminaria stipe or branch parts can overcome the problems that have been demonstrated. The base body here can preferably be a rod-like, solid element, which can also be referred to as a solid rod, and/or can have a rod-like, in particular cylindrical, shape. It has been shown that the use of a rod-like or stick-shaped body entails the advantage that the bioinert body is more stable and exhibits a large dilation or expansion capacity. The cylindrical shape brings advantages in handling and in application in a method of tissue augmentation, since it can be inserted relatively easily at the desired position in the body.

The base body may also comprise a moisture—permeable shell filled with crushed laminaria stipes parts. These laminaria stipes parts can for example be grounded. In addition to the moisture permeability the shell should also be elastic. For example dialysis tubes may be used.

The surface of the bioinert body can have any desired configuration. Advantageously, it is smooth or has a grooved surface. The surface is selected appropriately according to the area of use.

An improved applicability of the bioinert body is obtained if the base body is sterilized, in particular X-ray sterilized. In this case further complications after insertion into the body are reduced.

Preferably, for example, 10 mm to 100 mm thick rods or cylinders are cut from the natural laminaria stipes, which are subsequently dried and then sterilized, in particular X-ray sterilized.

Advantageously, the bioinert body is used for application in a method of tissue augmentation, in which the bioinert body is inserted under a mucoperiosteal layer or above the periosteal within the mucous membrane and above a bone. The mucosa is preferably an oral mucosa and/or the bone is preferably a jawbone.

The application of the bioinert body according to the invention is explained further below. In particular, the advantages of the use of laminaria as the basic material for the base body are discussed in more detail.

The bio-body, which consists of dried and sterilized rod-shaped laminaria parts, e.g. from 10 mm to 100 mm in size, can be inserted under the oral mucoperiosteal layer through a single incision. It thus lies between the bone and the periosteum. This preferably takes place in an area of a planned bone augmentation, a bone graft to be covered or a jawbone to be covered.

The bioinert body absorbs tissue fluid at this site and then swells or grows, usually in a period of between 7 and 10 days, to its original size. In other words, it increases in size by at least four times its volume. Thus, it exerts a continuous, slowly increasing growth stimulus on the oral mucoperiosteal layer. This leads to an augmentation of the oral mucoperiosteal layer.

Thus, by means of a relatively small intervention, an excess of mucosa can be generated in the bone graft region, which then allows a tension-free covering of a bone graft with undamaged periosteum and a sufficient quantity of mucosa for a wound closure. Moreover, the wound closure is saliva-proof and the lowest possible tension is present on the periosteum and oral mucosa. A slitting of the non-stretchable periosteum, similar to the principle of a blind, for lengthening the mucosa which is attached to the periosteum and which is, in contrast, stretchable, can thus be avoided, and therefore the graft is covered by intact, unslit and thus undamaged periosteum, starting from which a healing and the desired ossification of the graft can begin.

A further advantage of the use of the bioinert body according to the invention is that the space around the bioinert body fills with blood, serum and intercellular fluid. Both blood and serum as well as intercellular fluid are body fluids rich in growth factors, which stimulate the differentiation of the mesenchymal stem cells in this space. The mesenchymal stem cells are present in both the blood and the periosteum. It should be borne in mind here that a generally optimal growth factor composition is usually present in endogenous blood or serum. This enhances the growth of the oral mucosa.

After for example approx. 14 to 21 days, the swollen, enlarged bioinert body can be removed again. Another advantage of the use of laminaria as a material is that it is inert with respect to the attachment of most, if not all, body own cells. This means that the bioinert body can be removed again relatively simply and without problems.

A desired graft material can now be inserted or implanted in the prepared area by any desired technique. It is advantageous here that, as a result of the enlarged, tube-like oral mucoperiosteal layer, only a small wound closure is needed after insertion of the graft. This reduces the risk of suture dehiscence, with possible exposure and infection of the bone graft.

In an open method in which the mucosa is severed over a large area in order to insert the graft, the application of the bioinert body according to the invention again offers the advantage of permitting a substantially saliva-proof and mainly tension-free wound closure in a similar manner as a result of the augmented mucosa. Thus, the risk of the occurrence of the complications described above is reduced.

By avoiding slitting the periosteum, the bone graft is surrounded by a completely intact and unbroken periosteum, which in turn results in improved conditions for healing of the graft.

As a result of the iodine content of the laminaria seaweed material, whereby iodine is released by the bioinert body, this technique additionally has a local antibacterial effect in the region of the future implant, so that the risk of an infection of the future implant bed is reduced.

The bioinert body according to the invention, when applied in a method of tissue augmentation, thus makes it possible, in a simple manner which is relatively problem-free for the patient, to achieve the creation of sufficient tissue which will available for a subsequent operation or treatment.

1. A bioinert body,
having a base body,
which grows to at least four times its volume when hydrated,
which substantially consists of dried laminaria stipe parts,
for application in a method of tissue augmentation.

2. The bioinert body according to claim 1,
wherein the base body is a solid rod.

3. The bioinert body according to claim 1,
wherein the base body has a moisture-permeable shell which is filled with comminuted laminaria stipe parts.

4. The bioinert body according to claim 1,
wherein the base body has a rod-like, in particular cylindrical, shape.

5. The bioinert body according to claim 1,
wherein the base body has a smooth or grooved surface.

6. The bioinert body according to claim 1,
wherein the base body is sterilized, in particular X-ray sterilized.

7. The bioinert body according to claim 1, for application in a method of tissue augmentation in which the bioinert body is inserted below a mucoperiosteal layer or above the peristeum within the mucous membrane and above a bone.

8. The bioinert rod according to claim 7,
wherein the mucosa is an oral mucosa and/or that the bone is a jawbone.

9. The bioinert body according to claim 7,
wherein the body can be inserted by means of an incision.

10. The bioinert body according to claim 1,
wherein the tissue augmentation is carried out in the area of a bone that is to be built up.

11. The bioinert body according to claim 1,
wherein the tissue proliferation lies in the area of a bone augmentation to be covered or a jaw bone to be covered.
